(19) United States
(12) Patent Application Publication
(10) Pub. No.: US 2003/0050944 A1
(43) Pub. Date: Mar. 13, 2003

(54) Device for computing discrete transforms

(76) Inventors: Olivier Gay-Bellile, Paris (FR); Eric Dujardin, Fremont, CA (US)

Correspondence Address: U.S. Philips Corporation, 580 White Plains Road, Tarrytown, NY, 10591, US

(21) Appl. No.: 10/222,237

(22) Filed: Aug. 16, 2002

(30) Foreign Application Priority Data
Aug. 21, 2001 (FR) 0110958

(51) Int. Cl. G06F 17/14

(52) U.S. Cl. 708/400

(57) ABSTRACT

The invention relates to a device (FFTP) for computing discrete transforms. The device comprises a local memory (RAM2) for registering results of sub-transform computations, a sub-transform computation comprising several computation layers. The device is characterized by computation means (CAL_M) which are capable of interlacing computation layers of two or several consecutive sub-transforms of the same size.

The invention relates to a device for computing discrete transforms comprising sub-transforms, said device comprising a local memory for registering results of sub-transform computations, a sub-transform computation comprising several computation layers. The invention also relates to a computation method adapted to said device.

The invention is particularly used in channel decoding during terrestrial transmissions of signals.

The document “A power-efficient Single-Chip OFDM Demodulator and Channel Decoder for multimedia Broadcasting” published by IEEE International Solid-State Circuits in 1998, no. 0-7803-4344-1, describes a device for computing discrete transforms, here Fourier transforms in an OFDM (“Orthogonal Frequency Division Multiplexing”) receiver. A Fourier transform has a variable size of 1024 to 8192 data or samples for an OFDM receiver. When said receiver receives a signal, it receives the signal in the form of sample packets in a global memory, in which the packets have a variable size in accordance with the standard used. In the DVB-T standard (“Digital Video Broadcasting Terrestrial”), published by ETSI (“European Telecommunications Standard Institute”), which uses OFDM receivers, the packet size is 2 kbytes or 8 kbytes. The receiver comprises a computation device with which a Fourier transform on the received samples of a packet can be computed.

The computation of a transform is split up into several sub-transform computations. Intermediate and final results of the sub-transform computations are registered in the local memory. Said local memory is thus used at a larger frequency than the global memory. A sub-transform computation itself is split up into several elementary computation layers referred to as butterflies, in which a butterfly computation requires two input data and supplies two computed output data. An elementary module allows computation of a butterfly and comprises adders and multipliers.

A well-known technique of transform computation is the use of a device for computing discrete transforms such as a pipeline processor. To effect the multiplications and additions of the butterfly in parallel, the processor executes the set of butterfly computations of a layer of a sub-transform by performing a butterfly computation in each clock cycle and subsequently it performs the set of butterfly computations of the next layer of the sub-transform, etc. A butterfly computation is effected with a certain latency, the latency being a number of clock cycles to be observed between an input data and a computed output data of a butterfly computation.

This technique poses a problem of dependence of data between computations of a sub-transform which involves an interruption of the processor.

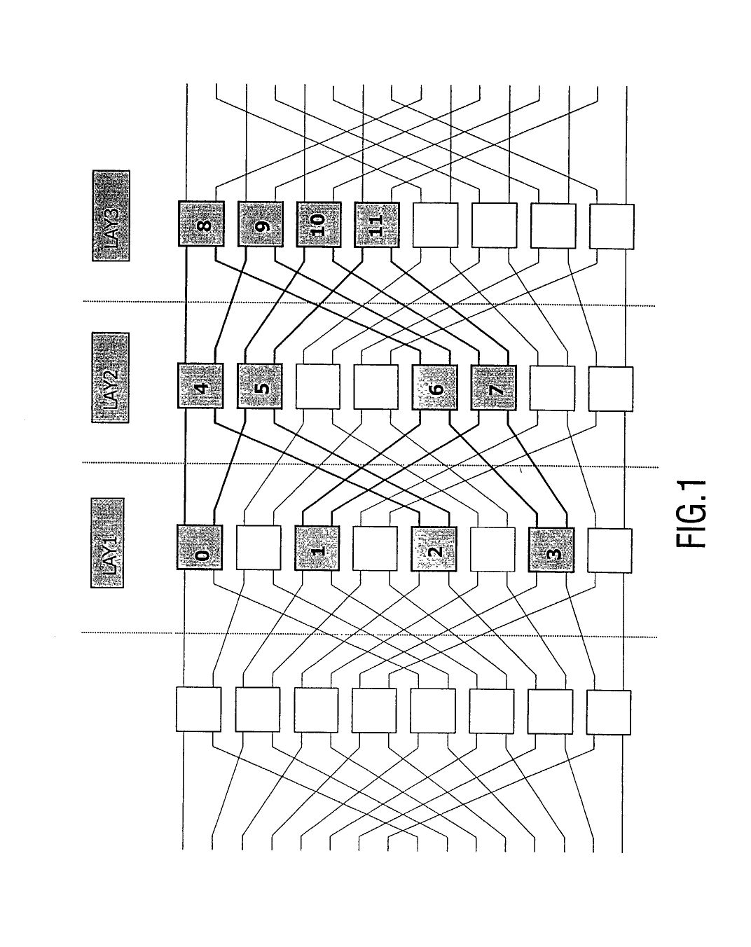

FIG. 1 shows such a dependency. FIG. 1 shows a network for interconnecting a discrete Fourier transform of 16-data. This transform is composed of two sub-transforms of 8-data each. An 8-data sub-transform comprises 3 layers LAY1, LAY2 and LAY3 of butterfly computations. 12 Butterfly computations must be consecutively computed for realizing an 8-data Fourier sub-transform, i.e. 4 butterflies for a layer LAY. The butterflies used for starting the computation of a sub-transform are represented by black blocks in the Figure. The butterflies used are computed in an optimal order which is represented by a number within said block.

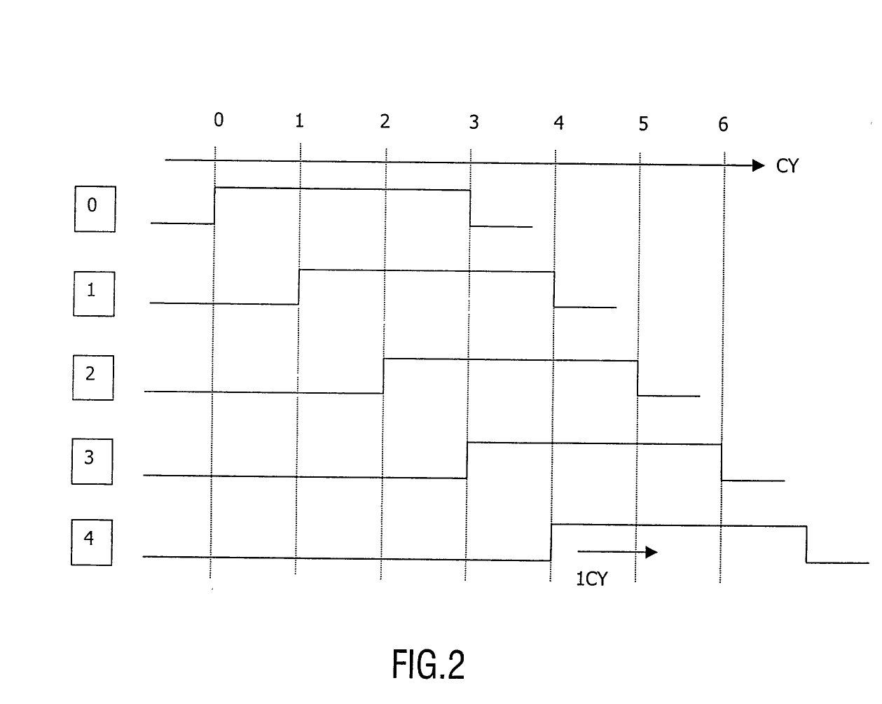

Let us take the example of the butterfly labeled 4, which is the first to be computed in the second layer LAY2 of the 8-data sub-transform. This butterfly labeled 4 requires two input data coming from two computed butterflies 0 and 1 of the first layer LAY1. As is shown in FIG. 2, the processor performs a butterfly computation in each cycle CY. It must wait 4 cycles before it can start the computation of the butterfly labeled 4. However, likewise as in a layer LAY, there are only 4 butterfly computations if the latency is higher than 2, while the data coming from the butterflies 0 and 1 and required for the computation of the butterfly 4 arrive with a delay. As can be seen in FIG. 2, said data arrive with a delay cycle if the latency is equal to 3. Consequently, to compute the butterfly labeled 4, the processor must wait 1 cycle before it can perform said butterfly computation. Generally, the processor must wait L-2 cycles in this example before it can perform the whole butterfly computation of the second layer LAY2. The processor is thus interrupted in its computations.

Thus, one technical problem to be solved by the present invention is to propose a device for computing discrete transforms comprising sub-transforms, said device comprising a local memory for registering results of sub-transform computations, a sub-transform computation comprising several computation layers, as well as an associated computation method, with which the waiting problem of the device during a sub-transform computation can be avoided.

In accordance with a first object of the present invention, a solution to the technical problem posed is characterized in that the computation device comprises computation means which are capable of interlacing computation layers of a first sub-transform and a second sub-transform.

In accordance with a second object of the present invention, this solution is characterized in that said computation method comprises a step of interlacing computation layers of a first sub-transform and a second sub-transform.

As will be described in detail hereinafter, such an interlace allows an increase of the computation time between two consecutive layers. Consequently, a data used for an elementary module of a sub-transform will have more time to be sent from one elementary module to another and it will no longer be necessary to interrupt the processor.

These and other aspects of the invention are apparent from and will be elucidated, by way of non-limitative example, with reference to the embodiment(s) described hereinafter.

In the drawings:

FIG. 1 shows diagrammatically an interconnection network for a discrete transform computation performed by means of a device in accordance with the state of the art,

FIG. 2 is a diagram showing a set of cycles of performing elementary computations by means of the computation device of the prior art, shown in FIG. 1,

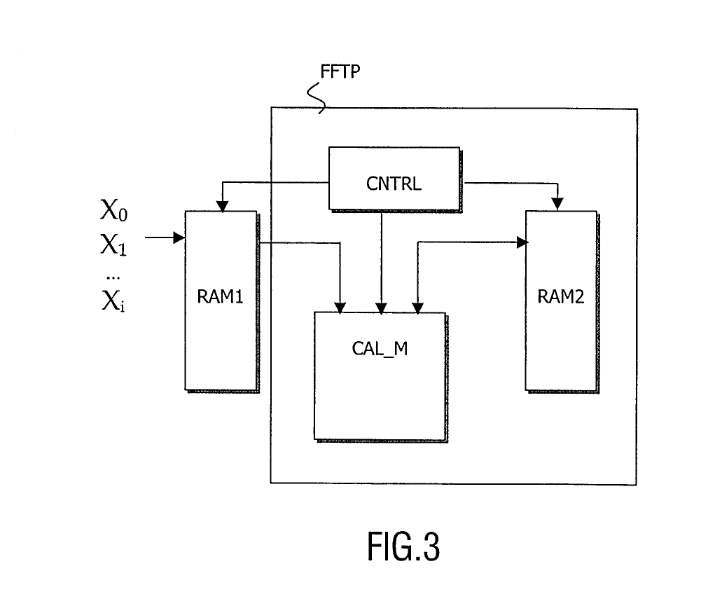

FIG. 3 is a diagram of a computation device according to the invention,

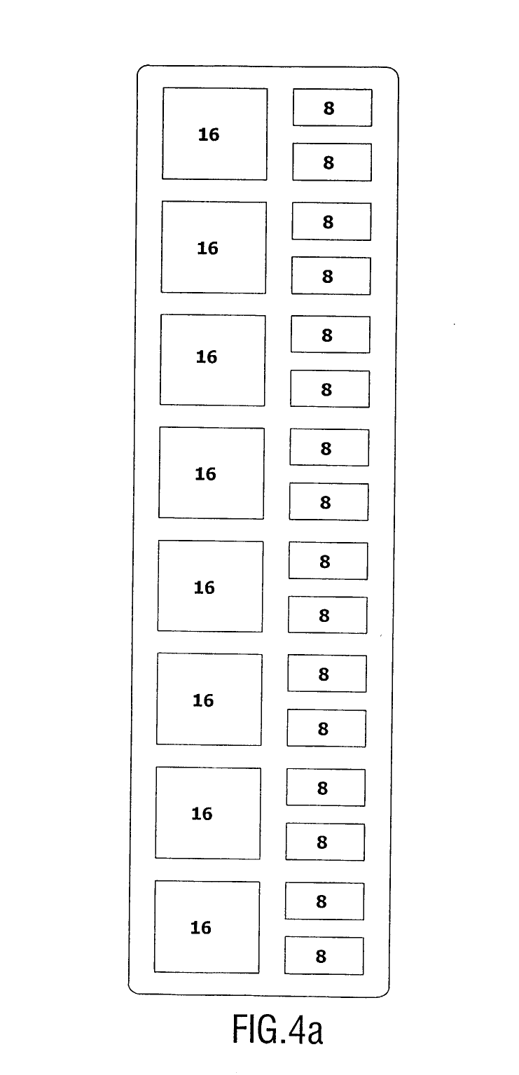

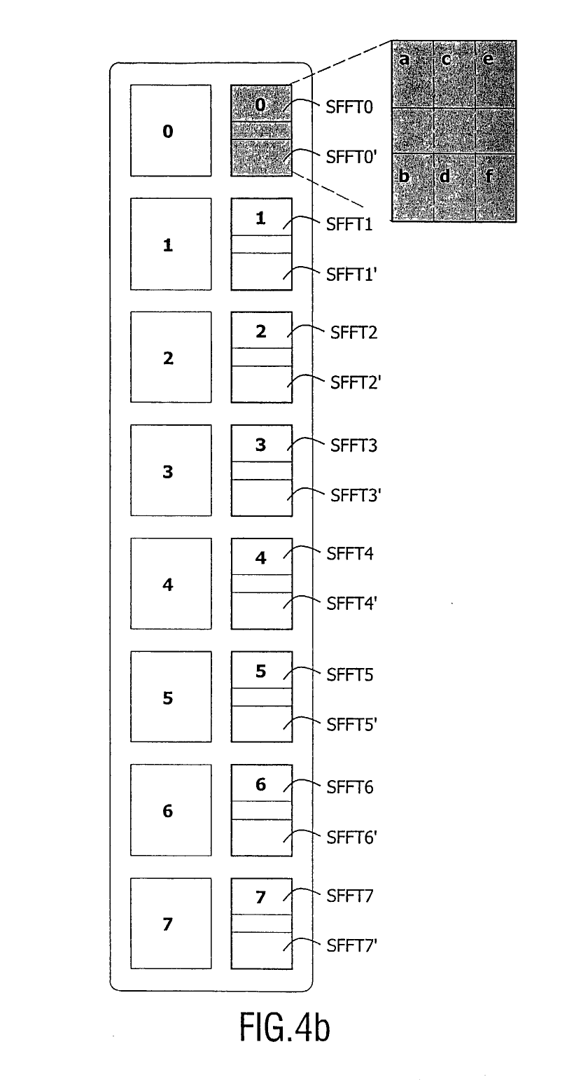

FIG. 4a represents a discrete transform computation by means of the device of FIG. 3,

FIG. 4b shows details of the discrete transform computation in FIG. 4b by means of the device of FIG. 3,

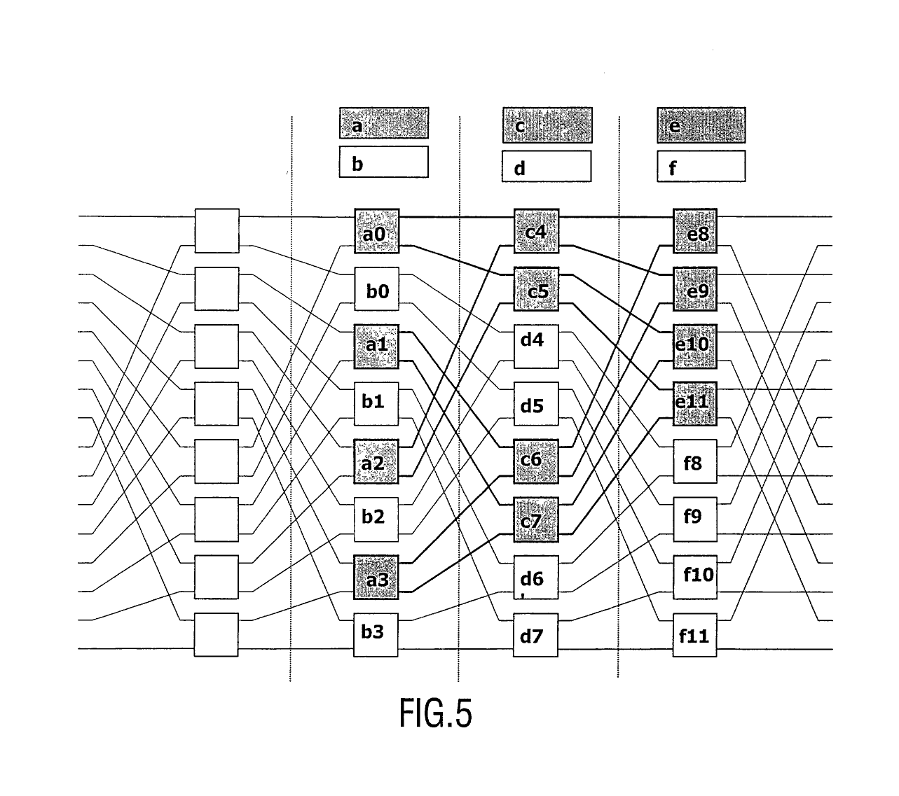

FIG. 5 shows diagrammatically an interconnection network for a discrete transform computation performed by means of the computation device of FIG. 3, and

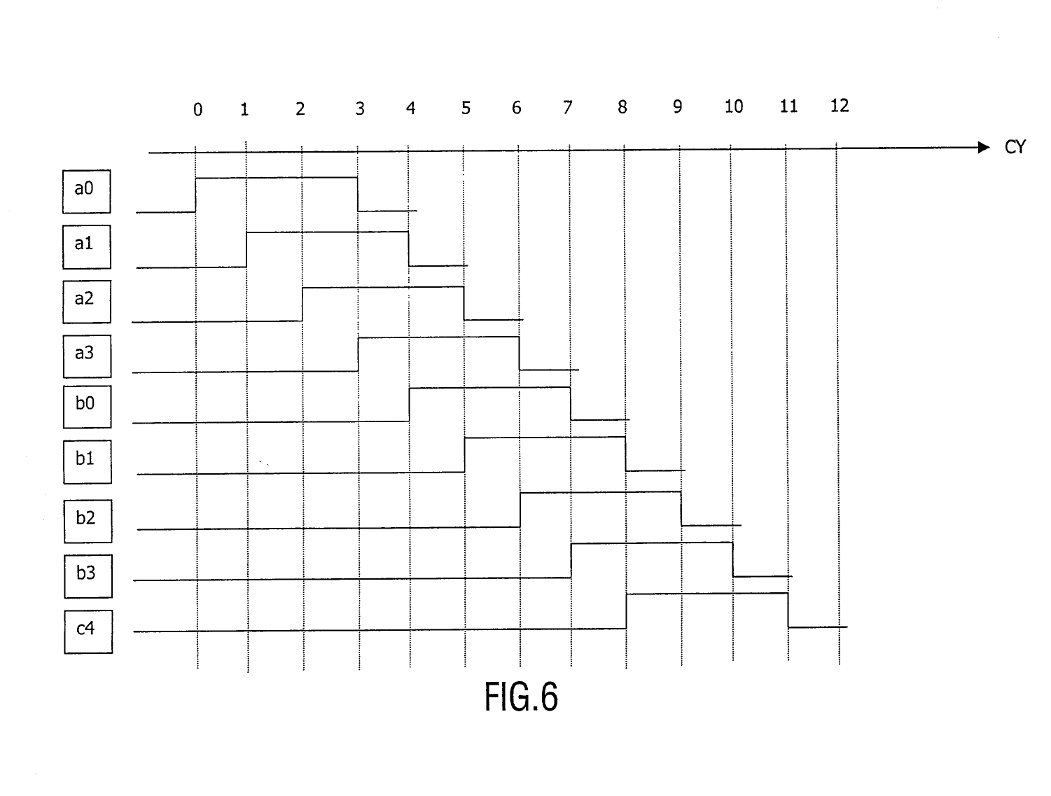

FIG. 6 is a diagram showing a set of cycles of performing elementary computations by means of the computation device of FIG. 3.

The present disclosure of the invention relates to an example of the device for computing discrete transforms in a receiver used in the field of terrestrial television.

A transmitter and a receiver are used within transmission systems in the field of signal transmissions through a channel (not shown) particularly in the field of terrestrial television. The transmitter modulates the signal transforming a digital signal into an analog signal and sends said signal through the channel. At the output of the channel, the signal is received by the receiver which demodulates the signal transforming the analog signal into a digital signal.

In the case of the DVB-T standard (“Digital Video Broadcasting Terrestrial”), different techniques are used, such as the OFDM technique (“Orthogonal Frequency Division Multiplexing”) in Europe during a demodulation. This technique particularly uses rapid computations of discrete Fourier transforms.

During reception of a digital signal, the receiver receives this signal in the form of sample packets Xᵢ (i≧0). The samples are received by an OFDM receiver of the DVB-T standard, which comprises a demodulator, in packets with a size of 2 kbytes or 8 kbytes. The packets are demodulated by the receiver.

The demodulation is effected by means of a device FFTP for computing discrete transforms, comprised in said receiver, a discrete transform comprising sub-transforms. Said computation device FFTP is shown in FIG. 3, and is generally a processor. It comprises a local memory RAM2, control means CNTRL and computation means CAL_M. The device FFTP for computing transforms also has access to an external global memory RAM1.

The global memory RAM1 allows storage of samples Xi of the received signal and the local memory RAM2 allows registering of the results of the sub-transform computations, a sub-transform computation comprising several computation layers LAY. Said memories are preferably volatile and rewritable memories.

In order to compute a discrete transform, the following steps are performed. The computation of a discrete transform having a size of 128 data or samples is taken by way of example. As is shown in the example illustrated in FIGS. 4a and 4b, such a transform computation can be split up into 8 computations of 16-pixel sub-transforms, followed by 16 computations of 8-data sub-transforms. An 8-data sub-transform comprises 3 layers, each layer comprising 4 elementary computations to be performed, an elementary computation being currently referred to as butterfly, a butterfly computation requiring two input data and supplying two computed output data. An elementary module (not shown) comprised in the computation means CAL_M allows computation of a butterfly. Such a module comprises additions and multiplications and several registers. A butterfly computation is performed with a certain latency L, the latency L being a number of clock cycles to be observed between an input data and a computed output data of a butterfly computation.

In a first step, the control means CNTRL configure the global memory RAM1 and the local memory RAM2 so as to receive packet samples Xᵢ and results of transform computations, respectively. The configuration is made as a function of the number of Fourier transforms used during a demodulation, which transforms have a variable size, as the case may be, in this case 2 kbytes or 8 kbytes. This configuration step is known to those skilled in the art and will therefore not be described in further detail.

In a second step, the computation means CAL_M compute the sub-transforms by interlacing computation layers of a first sub-transform and a second sub-transform in an alternating manner. The interlace is preferably effected between two consecutive sub-transforms of the same size. For the 8-data sub-transforms, for example, the processor thus starts the computations of the 8-data sub-transforms in the order indicated in FIG. 4b, i.e. by starting with the two first sub-transforms, subsequently the two next sub-transforms, etc. There is thus, for example, an interlace with the two first 8-data sub-transforms labeled SFFT0 and SFFT0′. Said sub-transforms SFFT0 and SFFT0′ comprise 3 layers labeled a, c, e and b, d, f, respectively. As is shown in FIG. 5, said layers a, c, e and b, d, f comprise each 4 elementary computations to be performed. The layer a thus comprises the butterflies labeled a0, a1, a2 and a3; the layer c comprises the butterflies labeled c4, c5, c6 and c7; the layer e comprises the butterflies labeled e8, e9, e10 and e11. Similarly, the layer b comprises the butterflies labeled b0, b1, b2 and b3; the layer d comprises the butterflies labeled d4, d5, d6 and d7; the layer f comprises the butterflies labeled f8, f9, f10 and f11. In contrast to the prior art, which performs these butterfly computations in the sequencing order of these butterflies, the computation device according to the invention performs the butterfly computations in the following manner:

computation of the first layer a of the first sub-transform SFFT0, the butterfly computations of said layer being performed in the order indicated in FIG. 5, i.e. computation of the butterflies a0, then a1, a2, and a3;

computation of the first layer b of the second sub-transform SFFT0′, the butterfly computations of said layer being performed in the order indicated in FIG. 5, i.e. computation of the butterflies b0, then b1, b2, and b3;

computation of the second layer c of the first sub-transform SFFT0, the butterfly computations of said layer being performed in the order indicated in FIG. 5, i.e. computation of the butterflies c4, then c5, c6, and c7;

computation of the second layer d of the second sub-transform SFFT0′, the butterfly computations of said layer being performed in the order indicated in FIG. 5, i.e. computation of the butterflies d4, then d5, d6, and d7;

computation of the third layer e of the first sub-transform SFFT0, the butterfly computations of said layer being performed in the order indicated in FIG. 5, i.e. computation of the butterflies e8, then e9, e10, and e11;

computation of the third layer f of the second sub-transform SFFT0′, the butterfly computations of said layer being performed in the order indicated in FIG. 5, i.e. computation of the butterflies f8, then f9, f10, and f11; and so forth until there are no longer any 8-data sub-transforms to be computed, i.e. until the sub-transforms SFFT7 and SFFT7′.

It will be noted that an algorithm referred to as the Cooley-Tukey algorithm is used for performing such butterfly computations, which algorithm is also known as the radix 2 algorithm or double radix, in which a radical may vary from 2 to 4. A transform computation using a radix 2 requires a number of samples which is a power of 2. For example, for computing a transform of 2 kbytes, there will be 256 16-data sub-transform computations (i.e. 32 radix 2 elementary computations per sub-transform) and 256 8-data sub-transform computations (i.e. 12 radix 2 elementary computations per sub-transform). As a butterfly computation and particularly the Cooley-Tukey algorithm are well known to those skilled in the art, they will not be described here.

With reference to the scheme 5, in the diagram of FIG. 6, the butterfly labeled c4 which is the first to be computed in the second layer c of the first 8-data sub-transform SFFT0 and in which the latency L is equal to 3 is taken as an example. The butterfly c4 requires the data of the butterflies a0 and a1. As can be seen, the first layer a of the first sub-transform SFFT0, i.e. the butterflies a0, a1, a2 and a3 are computed first. Secondly, the first layer b of the second sub-transform SFFT0′, i.e. the butterflies b0, b1, b2 and b3 are computed. Finally, the butterfly c4 is computed in the 8^{th} cycle. The data resulting from the computation of the butterflies a0 and a1 of the first layer a have, in this case, the time to be transmitted to the butterfly c4.

The sequencing order of the computations between two sub-transforms described above is based on an optimal computation order for a sub-transform referred to as “perfect shuffle”. This permutation or optimal order for a sub-transform corresponds to the increasing order of butterfly blocks and layers. In the shaded parts in FIG. 5, the optimal order for the first sub-transform SFFT0 corresponds to the computations of the 1^{st} block a0, the 2^{nd} block al, the 3^{rd} block a2, the 4^{th} block a3 of the 1^{st} layer a, subsequently computations of the 1^{st} block c4, the 2^{nd} block c5, the 3^{rd} block c6, the 4^{th} block c7 of the 2^{nd} layer c, and finally computations of the 1^{st} block e8, the 2^{nd} block e9, the 3^{rd} block e10 and the 4^{th} block e11 of the 3^{rd} layer e. In the white parts of FIG. 5, the optimal order for the second sub-transform SFFT0′ corresponds to the computations of the 1^{st} block b0, the 2^{nd} block b1, the 3^{rd} block b2, the 4^{th} block b3 of the 1^{st} layer b, subsequently computations of the 1^{st} block d4, the 2^{nd} block d5, the 3^{r5d} block d6, the 4^{th} block d7 of the 2^{nd} layer d, and finally computations of the 1^{st} block f8, the 2^{nd} block f9, the 3^{rd} block f10 and the 4^{th} block f11 of the 3^{rd} layer f.

For a given sub-transform, a butterfly, j of a layer i+1 thus depends on the butterflies j/2 and (j/2+Ns/4) of the layer i of said transform, wherein Ns is the size of the sub-transform to be computed. For example, the 2^{nd} butterfly C6 of the 2^{nd} layer of the first sub-transform SFFT0 depends on the butterflies 2/2=1 and 2/2+8/4=3 of the 1^{st} layer of said sub-transform, being butterflies a0 and a2. Consequently, the time between a computation of a block of a layer i and a computation of a block depending on the next layer i+1 corresponds to a number of cycles Tdep (one block being computed per cycle) such that Tdep=Ns/2−(j/2+Ns/4)=j=Ns/4+j−(j/2), wherein Ns/2 is the number of butterflies to be computed in a layer. In the worst case, when j=0, the minimum time Tdepmin is equal to Ns/4. As Tdep must be>L, this is equivalent to Ns>4*L.

Advantageously, for a sub-transform computed by means of an optimal radix 2 permutation method, when the size of a sub-transform is smaller than or equal to 4 times the latency L of a radix 2 butterfly computation of a sub-transform, the computation means CAL_M effect an interlace on this sub-transform, as described previously. In other words, when the size of a sub-transform is higher than 4 times the latency L, the computation means CAL_M do not effect an interlace.

In the example mentioned above, it is not necessary to effect such an interlace for the 16-data sub-transforms when there is a latency L of 3. Indeed, for a layer of a 16-data sub-transform, it is necessary to compute 8 butterflies. Consequently, for a latency of 3, the data required for the different computations have the time to be transmitted for a butterfly. There is effectively the size of the sub-transform which is larger than 4 times the latency L. In this case, it is thus not necessary to effect the interlace so as to lengthen the time of transmitting data for 16-data sub-transforms. Prior or subsequent to the computations of the 8-data sub-transforms, the processor thus performs the computation of the 8 16-data sub-transforms without interlace in the order indicated in FIG. 4a.

It will also be noted that, when the latency period L is equal to 1, i.e. as soon as a computation is started, a result is obtained, while the computation means CAL_M never effect an interlace because in this case all the data of a layer will be available as soon as the butterfly computations of the next layer start.

Such an interlace thus has the advantage of leaving time to the data which are necessary for the butterfly computations, and of being transmitted from one butterfly to another, and this without the processor FFTP waiting for the transmission of such data during one cycle or more.

Finally, the invention has the supplementary advantage of using a local memory RAM2 and of consequently less using the global memory RAM1. Indeed, at each sub-transform computation, it is the local memory RAM2 which is used. The device FFTP for computing transforms essentially only accesses the global memory RAM1 for transferring results of sub-transforms. Thus, there is not only a reduction of the energy consumption, because an access to the local memory consumes less than an access to the global memory, but also the possibility of freeing the global memory for access operations by devices other than the device FFTP for computing transforms.

It should be noted that the scope of the invention is by no means limited to the embodiment described and it extents, for example, to other embodiments in which other algorithms are used.

The invention may also be used for demodulators other than those based on the OFDM technique. For example, it may be used for the VSB technique (“Vestigial Sideband Modulation”) used in the United States in a frequency domain. This VSB technique also uses Fourier transforms when it is used in a frequency domain. During reception of a signal, the receiver receives a digital signal in the form of sample packets of 1 kbyte or 2 kbytes.

It should also be noted that the invention is by no means limited to Fourier transforms but may extend to other discrete transforms such as a discrete cosine transform DCT used, for example, in a video processing application.

The invention is by no means limited to the field of terrestrial television but may extend to other fields, notably to all those using a system with discrete transforms.

Any reference sign in this text shall not be construed as limiting the claim. Use of the verb “comprise” and its conjugations does not exclude the presence of elements or steps other than those stated in the claims. Use of the article “a” or “an” preceding an element or step does not exclude the presence of a plurality of such elements or steps.

1. A device (FFTP) for computing discrete transforms comprising sub-transforms, said device comprising a local memory (RAM2) for registering results of sub-transform computations, a sub-transform computation comprising several computation layers, characterized in that it comprises computation means (CAL_M) which are capable of interlacing computation layers of a first sub-transform and a second sub-transform.

2. A computation device (FFTP) as claimed in claim 1, characterized in that the computation means (CAL_M) are capable of effecting an interlace between two consecutive sub-transforms of the same size.

3. A computation device (FFTP) as claimed in claim 1, characterized in that the computation means (CAL_M) effect an interlace if a sub-transform has a size which is smaller than or equal to four times a latency (L) of an elementary computation of a sub-transform.

4. A computation device (FFTP) as claimed in claim 3, characterized in that a sub-transform is based on a computation method with an optimal permutation.

5. A method of computing discrete transforms comprising sub-transforms, said method being suitable for registering results of sub-transform computations in a local memory (RAM2), characterized in that it comprises a step of interlacing computation layers of a first sub-transform and a second sub-transform.

6. A method of computing transforms as claimed in claim 5, characterized in that the interlace is effected between two consecutive sub-transforms of the same size.

7. A method of computing transforms as claimed in claim 5, characterized in that the interlace is effected if a sub-transform has a size which is smaller than or equal to four times a latency (L) of an elementary computation of a sub-transform.

8. A method of computing transforms as claimed in claim 7, characterized in that a sub-transform is based on a computation method with an optimal permutation.

9. A receiver comprising a demodulator with a device (FFTP) for computing discrete transforms as claimed in claim 1, said receiver being adapted to receive a packet of samples, said packet being demodulated by means of said device (FFTP).

10. A transmission system comprising a transmitter for modulating a signal and sending said signal via a channel to a receiver, and said receiver for demodulating said signal by means of a device (FFTP) as claimed in claim 1.
